(19) United States
(12) Patent Application Publication
(10) Pub. No.: US 2024/0195254 A1
(43) Pub. Date: Jun. 13, 2024

(54) ELECTRIC MOTOR STATOR

(71) Applicants: HONDA MOTOR CO., LTD., Tokyo (JP); Nitto Shinko Corporation, Sakai (JP); Nitto Denko Corporation, Osaka (JP)

(72) Inventors: Shogo Miyazaki, Wako-shi (JP); Keiya Nimura, Wako-shi (JP); Yuto Suzuki, Osaka (JP); Satoshi Ueda, Osaka (JP); Osamu Kato, Sakai (JP)

(21) Appl. No.: 18/527,889

(22) Filed: Dec. 4, 2023

(30) Foreign Application Priority Data
Dec. 8, 2022 (JP) 2022-196476

(51) Int. Cl. H02K 3/30; H02K 1/16; H02K 3/34

(52) U.S. Cl. CPC H02K 3/30; H02K 1/16; H02K 3/345

(57) ABSTRACT

An electric motor stator includes a stator core in a tubular shape, which stator core has slots in which insulating paper and a winding are fixed with varnish, and at a first temperature obtained by heating, an adhesive force of an adhesive provided on at least one side of a base material of the insulating paper is less than an adhesive force of the varnish.

### INCORPORATION BY REFERENCE

The present application claims priority under 35 U.S.C.§ 119 to Japanese Patent Application No. 2022-196476 filed on Dec. 8, 2022. The content of the application is incorporated herein by reference in its entirety.

### BACKGROUND OF THE INVENTION

### Field of the Invention

The present invention relates to an electric motor stator.

### Description of the Related Art

An electric motor stator is disclosed in which varnish permeates into gaps in slots to fix insulating paper and a winding to a stator core (for example, see Japanese Patent No. 4973420). In addition, a technique using a foam insulating paper is known as a method of fixing a winding (see, for example, Japanese Patent No. 5497532).

The varnish impregnation rate greatly varies due to narrow space inside each slot, and the varnish is generally impregnated to the extent that the varnish overflows the slot. Great variation in the varnish impregnation rate increases variation in the winding adhesive force (also called adhesive strength or fixing strength). This increased variation in the adhesive force may require time to separate the winding, or may cause a strong adhesive force making it impossible to separate the winding.

Further, when the occupancy rate in the slots (the proportion of the winding included in the slots) is great, dismantling by a crushing method is common. In the case of the crushing method, the metal material of the winding and other materials are mixed together and are recycled as low-grade materials, and recycling of the stator core (electromagnetic steel plates) is also difficult.

The present invention has been made in view of the above-mentioned circumstances, and it is an object of the present invention to provide an electric motor stator that is suitable for recycling a winding and a stator core without being affected by variation in varnish impregnation rate.

### SUMMARY OF THE INVENTION

There is provided an electric motor stator, including a stator core in a tubular shape, the stator core having slots in which insulating paper and a winding are fixed with varnish, in which at a first temperature obtained by heating, an adhesive force of an adhesive provided on at least one side of a base material of the insulating paper is less than an adhesive force of the varnish.

It is possible to provide an electric motor stator that is suitable for recycling a winding and a stator core without being affected by variation in varnish impregnation rate.

### BRIEF DESCRIPTION OF THE DRAWINGS

FIG. 1 is a diagram showing an electric motor stator according to a first embodiment of the present invention;

FIG. 2 is a diagram schematically showing a cross-sectional structure of insulating paper together with a stator core and a winding;

FIG. 3 is a diagram showing a crushing method;

FIG. 4 is a diagram showing an extraction method; and

FIG. 5 is a diagram schematically showing a state of an extraction step in a second embodiment.

### DETAILED DESCRIPTION OF THE PREFERRED EMBODIMENTS

Embodiments of the present invention will be described below with reference to the drawings.

### First Embodiment

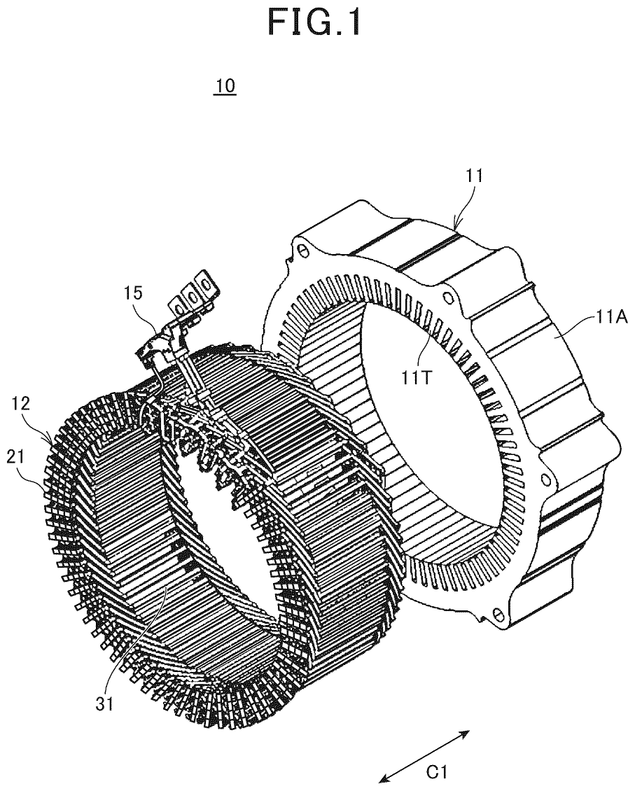

FIG. 1 is a diagram showing an electric motor stator according to a first embodiment of the present invention.

This electric motor stator 10 is a component that generates a rotating magnetic field, and is a stator used for an electric motor mounted on a vehicle. However, the electric motor stator 10 does not have to be limited to use for vehicles. The electric motor stator 10 is hereinafter referred to as “stator 10”.

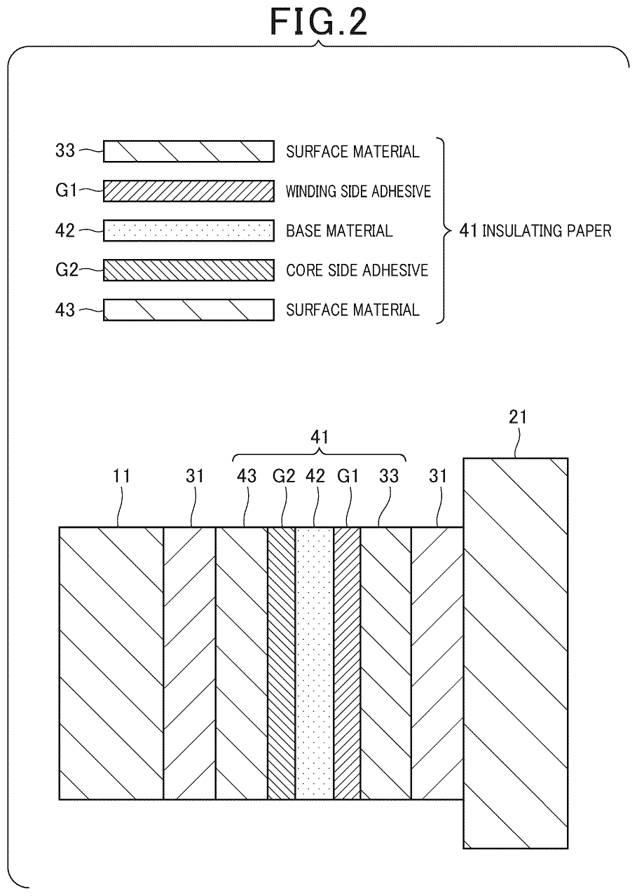

The stator 10 includes a stator core 11 in a tubular shape and a coil 12 attached to the stator core 11. The stator core 11 is provided with teeth 11T protruding to the inner circumferential side at intervals in the circumferential direction. A winding 21 is arranged in slots formed between the adjacent teeth 11T via insulating paper 41, and the slots are then impregnated with varnish 31 (FIG. 2), whereby the insulating paper 41 and the winding 21 are fixed to the stator core 11.

A reference character C1 in FIG. 1 indicates the axial direction of the stator 10, and the direction coincides with the axial direction of the electric motor. The winding 21 has a power distribution component 15 at the end portion thereof.

The coil 12 generally corresponds to the winding 21. In this description, when the coil 12 is separated after being assembled with the stator core 11, at least a portion of the insulating paper 41 adheres on the side of the coil 12. Therefore, the insulating paper 41 may also be described as a member on the side of the coil 12.

The stator core 11 is formed by laminating electromagnetic steel plates in the axial direction C1. The stator core 11 includes a yoke 11A forming an outer circumferential portion of the cylinder, and the teeth 11T protruding from the yoke 11A to the inner circumferential side.

The winding 21 is bundled into a predetermined shape and arranged in each slot formed between the teeth 11T. The winding 21 of this configuration is a so-called SC winding (segment conductor coil) in which U-shaped segment conductors are inserted into the slots so that each of the slots has the open side of the segment on one side and has the close side of the segment on the other side. Note that the winding 21 is not limited to the SC winding.

The winding 21 is a wire material in which a periphery of a metallic conductor such as steel wire, copper wire, or aluminum wire is covered with a coating having insulating properties (hereinafter referred to as an insulating coating). The insulating coating is, for example, an enamel coating.

Components of an enamel coating include, for example, polyurethane resin, polyester resin, polyamideimide, or the like.

The varnish 31 is a thermosetting resin with insulating properties, has adhesive properties to the winding 21 or the like, and functions as a protective film and fixing material for the winding 21. More specifically, varnish impregnation processing, in which the varnish 31 permeates into the gaps in the slots, causes the varnish 31 to bond the winding 21 or the like and solidifies. This enhances the insulating function of the coil 12, improves mechanical strength, prevents moisture, dust, or the like from entering inside the winding 21, and improves also heat dissipation. A wide range of known varnishes can be applied to the varnish 31.

The insulating paper 41 is a sheet material having insulating properties, and is also called an insulating sheet. Arranging the insulating paper 41 between the winding 21 and the stator core 11 enhances the insulating function between the winding 21 and the stator core 11.

FIG. 2 is a diagram schematically showing the cross-sectional structure of the insulating paper 41 together with the stator core 11 and the winding 21.

As shown in FIG. 2, the insulating paper 41 has a multi-layer structure consisting of a base material 42 and surface materials 33 and 43 bonded to the respective sides of the base material 42 with adhesives G1 and G2. The multi-layer structure facilitates obtaining the performance desired for the insulating paper 41, that is, facilitates improving insulating properties, heat-resisting properties, mechanical strength, or the like. For example, the base material 42 employs a polyamide epoxy alloy sheet material having high insulating properties and high heat-resisting properties, and the surface materials 33 and 43 employ aramid paper having high strength and high heat-resisting properties. In addition, the multi-layer structure allows providing an adhesive layer made of the adhesives G1 and G2 in the insulating paper 41.

In this description, when the adhesives G1 and G2 are separately described, the adhesive G1 located closer to the winding 21 than the base material 42 is referred to as “winding side adhesive G1” and the adhesive G2 located closer to the stator core 11 than the base material 42 is referred to as “core side adhesive G2”.

As shown in FIG. 2, there is the varnish 31 between the surface of the stator core 11 and the insulating paper 41 and between the surface of the winding 21 and the insulating paper 41. The adhesives G1 and G2 have temperature change characteristics such that their adhesive forces (also referred to as adhesive strength or fixing strength) decrease in high temperatures. In this configuration, the adhesives G1 and G2 satisfy the following conditions (1) and (2) through adjustment (selection, adjustment in components, etc.) of the adhesives G1 and G2.

Adhesive forces at normal temperature T0: Adhesives G1,G2≤Varnish 31 Condition (1)

Adhesive forces in extraction at temperature TX: Adhesives G1,G2<Varnish 31 Condition (2)

The normal temperature T0 is room temperature or the temperature before heating in a heating step described later. The normal temperature T0 is also the temperature within the temperature range when the electric motor stator 10 is in use, and can be said to be the temperature when the electric motor is in use.

The temperature TX in extraction is the temperature in an extraction step after heating in the heating step. The heating temperature that decreases the adhesive forces of the adhesives G1 and G2 to less than the adhesive force of the varnish 31 is a temperature T1 (hereinafter referred to as “high temperature T1”). When the adhesives G1 and G2 are once heated to the high temperature T1 and then have a temperature drop to the normal temperature T0, the adhesive forces of the adhesives return to substantially the same as the original adhesive forces or do not return to the original adhesive forces, so that the adhesive forces are maintained in a following state: adhesives G1, G2<varnish 31. The temperature TX in extraction just needs to be the high temperature T1 or an appropriate temperature after the high temperature T1 (for example, a normal temperature T0 such as the room temperature). Even if the varnish 31 is once heated to the high temperature T1, the adhesive force returns to substantially the same as the original adhesive force when the temperature drops to the normal temperature T0. The high temperature T1 corresponds to a “first temperature” of the present invention, and the normal temperature T0 corresponds to a “second temperature” of the present invention.

When this type of stator is recycled, the stator needs to be dismantled, and dismantling by a crushing method is conventionally common.

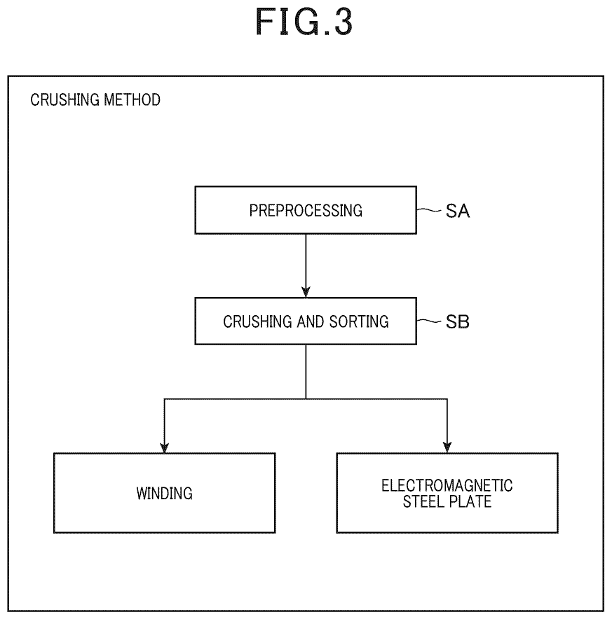

FIG. 3 is a diagram showing a crushing method.

The preprocessing shown in step SA is a step performed before crushing, and removes members that can be removed without crushing. In the crushing and sorting shown in step SB, the stator to be crushed is crushed with a predetermined crusher, and then crushed pieces of the winding and crushed pieces of the stator core (electromagnetic steel plate) are sorted out with a predetermined sorter.

However, even if sorting is performed, the broken pieces of the winding have a large content of impurities that are different from the metal of the winding, and will be recycled as low-grade materials. In addition, the crushed pieces of the electromagnetic steel plate also contain a material different from that of the electromagnetic steel plate. At present, it is generally difficult to recycle electromagnetic steel plates.

Separation by a method other than the crushing method causes the conventional stator to have variation in adhesive force of the winding with the varnish. This variation may require time to separate the winding or may cause a strong adhesive force making it impossible to separate the winding. In particular, since stators for vehicle electric motors are used in severe environments in terms of temperature, vibration, or the like, the stators each have a complicated structure and a winding or the like strongly bonded. Therefore, it has been difficult to separate the stators by a method other than the crushing method.

Contrarily, in this configuration, as described in the above condition (2), the adhesive forces at the temperature TX in extraction are set to “adhesives G1, G2 <varnish”, so that the winding 21 can be easily separated at the position of the adhesives G1 and G2, allowing for shortening the time required for separation and simplifying the equipment required for separation.

In addition, as described in the above condition (1), the adhesive forces at the normal temperature T0 are set to “adhesives G1, G2≤ varnish”, so that the adhesive forces in use for an electric motor, etc., are secured to the same extent as the adhesive force of the varnish 31, allowing for maintaining sufficient adhesive forces.

Next, a method for separating the winding 21 from the stator 10 will be described.

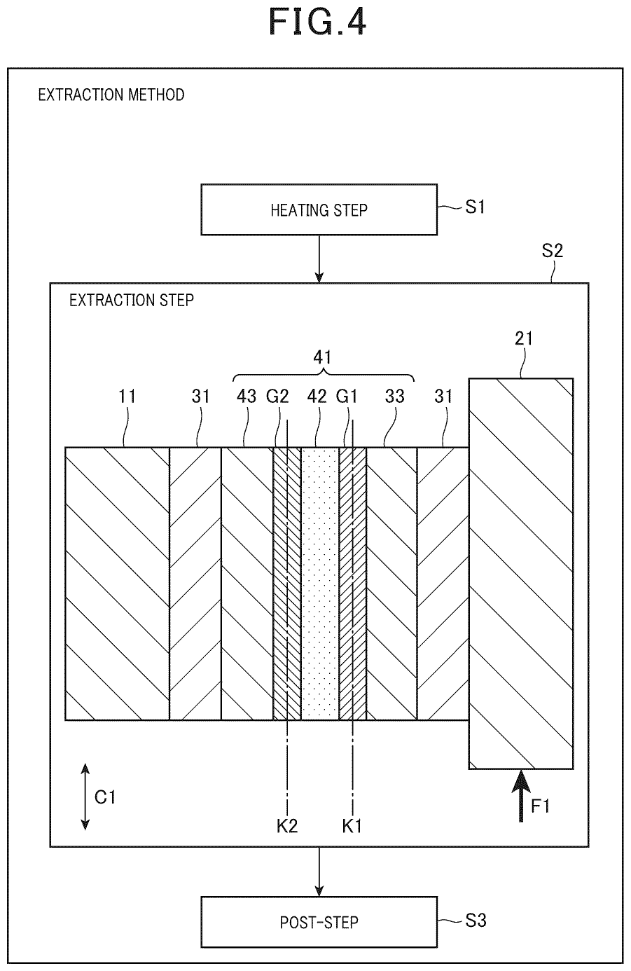

FIG. 4 is a diagram showing an extraction method for separating the winding 21.

In the heating step of step S1, the stator 10 is heated to a predetermined set temperature T2.

The set temperature T2 is a temperature to which the stator 10 is heated that is equal to or higher than the high temperature T1 that decreases the adhesive forces of the adhesives G1 and G2 to less than the adhesive force of the varnish 31. Note that the heating step can also be referred to as a burning step, a heating step, a heat treatment step, or the like.

In the extraction step, a load F1 for extracting the winding 21 from the stator core 11 in the axial direction C1 is applied to the stator 10. In the stator 10 having this configuration, the adhesive forces in extraction satisfy “adhesives G1, G2<varnish”. Therefore, the winding 21 can be separated from the stator core 11 at either of the position K1 of the adhesive G1 and the position K2 of the adhesive G2 (see FIG. 4).

Since the winding 21 can be separated at either of the positions K1 and K2 shown in FIG. 4, the portion that remains on the winding 21 side is just a portion of the insulating paper 41. In any of a case in which the adhesive forces of the adhesives G1 and G2 have not yet returned to the original adhesive forces after the heating step and a case in which the adhesive forces maintain a state of “adhesives G1, G2<varnish 31”, the adhesive forces in extraction satisfy “adhesive G1, G2<varnish”. This allows avoiding a case in which the winding 21 cannot be separated due to the strong adhesive force of the varnish 31, and allows the extraction load F1 to be relatively a small load.

Note that the high temperature T1 is set to a temperature at which the adhesive forces of the adhesives G1 and G2 sufficiently decrease to the extent that the winding 21 can be extracted, and the load F1 is set to a load suitable for separating the adhesives G1 and G2 at either of the positions K1 and K2. In other words, the adhesives G1 and G2 are adjusted or selected so as to have adhesive forces that allow the winding 21 to be extracted at the high temperature T1. Appropriate values need to be set for various parameters such as the set temperature T2, the high temperature T1, the temperature TX, the load F1, and the adhesive forces of the adhesives G1 and G2.

In the post-step of step S3, heat is applied to the surface of the winding 21 to burn off the insulating coating covering the surface of the winding 21. In this case, the insulating coating can be removed in a short time by applying high temperature heat that can burn off the insulating coating.

Removing the insulating coating can further reduce foreign materials remaining on the side of the separated winding 21. Therefore, the metal ratio on the side of the separated winding 21 can be further increased, making it suitable for recycling.

As described above, at the high temperature T1 obtained by heating (corresponding to the first temperature), the stator 10 of the present embodiment has the adhesive forces of the adhesives G1 and G2, provided on opposite sides of the base material 42 of the insulating paper 41, that are less than the adhesive force of the varnish 31. Therefore, raising the temperature to the high temperature T1 and then applying a load for extracting the winding 21 from the stator core 11 facilitates extraction of the winding 21 at either position of the adhesives G1 and G2. This allows for easily separating the winding 21 without being affected by variation in the varnish impregnation rate, and allows for reducing foreign materials remaining on the side of the winding 21. As a result, the winding 21 can be recycled as high-grade materials. Furthermore, it is possible to shorten the time required for separation and simplify the equipment required for separation. Further, the winding 21 can be separated from the stator core 11, making it easier to recycle the stator core 11, that is, to recycle the electromagnetic steel plates. These allow for providing a stator 10 suitable for recycling the winding 21 and the stator core 11.

Further, at the room temperature or at the normal temperature T0 corresponding to the temperature before heating (corresponding to the second temperature), the adhesive forces of the adhesives G1 and G2 on opposite faces of the base material 42 are equal to or lower than the adhesive force of the varnish 31. This allows the adhesives G1 and G2 to secure the adhesive forces to the same extent as that of the varnish 31 in use for an electric motor or the like, maintaining sufficient adhesive forces.

Further, the insulating paper 41 has the multi-layer structure including the base material 42 and the surface materials 33, 43 bonded to opposite sides of the base material 42. In this structure, the adhesive forces of the adhesives G1 and G2, which are respectively between the base material 42 and the surface material 33 and between the base material 42 and the surface material 43, become less than the adhesive force of the varnish 31, at the high temperature T1. This facilitates separation of the winding 21 at the position of the adhesives G1 and G2 after the temperature is set to the high temperature T1, to further facilitate reduction of foreign materials remaining on the side of the winding 21. This facilitates increase in the metal ratio on the side of the separated winding 21.

Furthermore, when the stator 10 is used for a vehicle electric motor, the stator 10 is used in severe environments in temperatures, vibrations, etc., and therefore has a configuration with a complicated structure and a winding, etc. strongly bonded. Even with this configuration, setting the temperature to the high temperature T1 facilitates easy separation of the winding 21.

In addition, performing the post-step that burns off the insulating coating covering the surface of the winding 21 can further reduce foreign materials remaining on the side of the winding 21 and can further increase the metal ratio on the side of the separated winding 21.

### Second Embodiment

A second embodiment differs from the first embodiment in that the second embodiment satisfies the following condition (3) in addition to condition (1).

Adhesive forces at temperature TX in extraction: winding side adhesive G1<core side adhesive G2<varnish 31 condition (3)

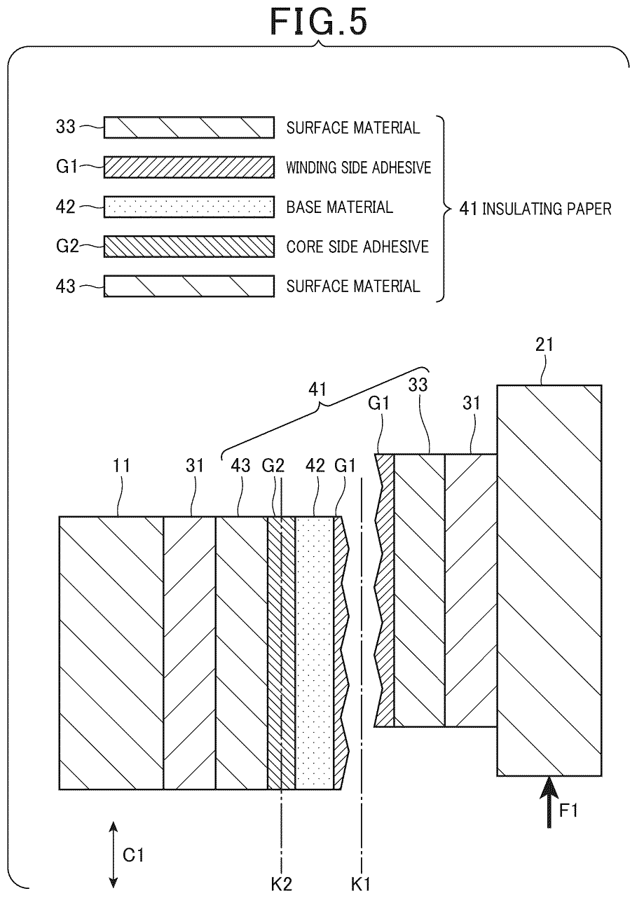

FIG. 5 is a diagram schematically showing a state of the extraction step in the second embodiment.

In the second embodiment, heating the stator 10 to the high temperature T1 provides a relationship in which: the adhesive force of the winding side adhesive G1 of the base material 42 is less than the adhesive force of the core side adhesive G2 of the base material 42; and the adhesive force of the core side adhesive G2 is less than the adhesive force of the varnish 31. The temperature TX in extraction just needs to be the high temperature T1 and an appropriate temperature after the high temperature T1 (for example, the same temperature as the normal temperature T0). Therefore, the winding 21 can be separated from the stator core 11 at the position K1 of the adhesive G1 in the extraction step, as shown in FIG. 5.

This case allows for avoiding a case in which the base material 42 of the insulating paper 41 remains on the side of the winding 21, in contrast to a case in which the core side adhesive G2 is separated at the position K2. Therefore, foreign materials remaining on the side of the winding 21 can be more stably reduced in the second embodiment than in the first embodiment, making it more suitable for recycling the winding 21 and the stator core 11.

Each of the embodiments described above is merely one aspect of implementation of the present invention, and can be modified and applied in any manner without departing from the spirit of the present invention. For example, the insulating paper 41 does not have to be limited to the above structure. For example, the insulating paper 41 may be changed to have an appropriate structure in an area where either of the adhesives G1 and G2 is used, or the insulating paper 41 may be changed in the material or the like as appropriate. In addition, although description has been made on the case in which the present invention is applied to the stator 10 with SC winding specifications, the present invention may be applied to a stator other than the stator with SC winding specifications. For example, some distributed winding stators are impregnated with varnish and have the same structures as shown in FIG. 2. Application of the present invention to such stators facilitates separating the winding 21 without being affected by variations in the varnish impregnation rate. In addition, the stator 10 is not limited to a stator for vehicles such as four-wheeled vehicles or saddle-ride vehicles, and may also be used as a stator for aircraft, ships, and other industries. Furthermore, the stator 10 may be widely used as a stator for rotating electric machines including electric motors and generators.

### [Configuration Supported by Above Embodiments]

The above embodiments support the following configurations.

(Configuration 1) An electric motor stator, including a stator core in a tubular shape, the stator core having slots in which insulating paper and a winding are fixed with varnish, in which, at a first temperature obtained by heating, an adhesive force of an adhesive provided on at least one side of a base material of the insulating paper is less than an adhesive force of the varnish.

This configuration applies a load for extracting the winding from the stator core after the temperature is set to the first temperature, to facilitate extraction of the winding at the position of the adhesive provided on at least one side of the base material of the insulating paper. This allows for easily separating the winding without being affected by variation in the varnish impregnation rate, and allows for reducing foreign materials remaining on the side of the winding, allowing for providing a stator suitable for recycling the winding and the stator core.

(Configuration 2) The electric motor stator according to Configuration 1, in which, at the first temperature, adhesive forces of adhesives provided on opposite sides of the base material are less than the adhesive force of the varnish.

This configuration facilitates separation of the winding at any of the positions of the adhesives provided on the opposite sides of the base material.

(Configuration 3) The electric motor stator according to Configuration 1 or 2, in which a relationship is provided, at the first temperature, in which an adhesive force of a winding side adhesive is less than an adhesive force of a core side adhesive, and the adhesive force of the core side adhesive is less than the adhesive force of the varnish, the winding side adhesive being provided on a side of the winding of the base material, the core side adhesive being provided on a side of the stator core of the base material.

This configuration facilitates separation of the winding at the position of the adhesive provided on the side of the winding of the base material after the temperature is set to the first temperature, facilitating stable reduction of foreign materials remaining on the side of the winding.

(Configuration 4) The electric motor stator according to any one of Configurations 1 to 3, in which, at a room temperature or a second temperature corresponding to a temperature before heating, adhesive forces of adhesives on opposite faces of the base material are equal to or less than the adhesive force of the varnish.

This configuration allows the adhesives to secure the adhesive forces to the same extent as the adhesive force of the varnish in use for an electric motor or the like, maintaining sufficient adhesive forces.

(Configuration 5) The electric motor stator according to any one of Configurations 1 to 4, in which the insulating paper has a multi-layer structure including the base material and surface materials bonded to opposite sides of the base material, and at the first temperature, adhesive forces of adhesives respectively between the base material and each of the surface materials are less than the adhesive force of the varnish.

This configuration facilitates separation of the winding at the positions of the adhesives on the opposite sides of the base material after the temperature is set to the first temperature, to further facilitate reduction of foreign materials remaining on the side of the winding.

(Configuration 6) The electric motor stator according to any one of Configurations 1 to 5, in which the electric motor stator is a stator used for a vehicle electric motor.

This configuration facilitates easy separation of the winding by setting the stator to the first temperature even in the stator for vehicle electric motor having a complicated structure and a winding, etc. strongly bonded.

### REFERENCE SIGNS LIST

10 . . . electric motor stator, 11 . . . stator core, 11A . . . yoke, 11T . . . teeth, 12 . . . coil, 21 . . . winding, 31 . . . varnish, 33, 43 . . . surface material, 41 . . . insulating paper, 42 . . . base material, G1 . . . winding side adhesive, G2 . . . core side adhesive, T0 . . . normal temperature (heating temperature, second temperature), TX . . . temperature in extraction, T1 . . . high temperature (heating temperature, first temperature), T2 . . . set temperature, C1 . . . axial direction.

What is claimed is:

1. An electric motor stator, comprising a stator core in a tubular shape, the stator core having slots in which insulating paper and a winding are fixed with varnish,
wherein, at a first temperature obtained by heating, an adhesive force of an adhesive provided on at least one side of a base material of the insulating paper is less than an adhesive force of the varnish.

2. The electric motor stator according to claim 1, wherein, at the first temperature, adhesive forces of adhesives provided on opposite sides of the base material are less than the adhesive force of the varnish.

3. The electric motor stator according to claim 1, wherein a relationship is provided, at the first temperature, in which an adhesive force of a winding side adhesive is less than an adhesive force of a core side adhesive, and the adhesive force of the core side adhesive is less than the adhesive force of the varnish, the winding side adhesive being provided on a side of the winding of the base material, the core side adhesive being provided on a side of the stator core of the base material.

4. The electric motor stator according to claim 1, wherein, at a room temperature or a second temperature corresponding to a temperature before heating, adhesive forces of adhesives on opposite faces of the base material are equal to or less than the adhesive force of the varnish.

5. The electric motor stator according to claim 1,
wherein the insulating paper has a multi-layer structure including the base material and surface materials bonded to opposite sides of the base material, and
at the first temperature, adhesive forces of adhesives respectively between the base material and each of the surface materials are less than the adhesive force of the varnish.

6. The electric motor stator according to claim 1, wherein the electric motor stator is a stator used for a vehicle electric motor.
